(19) United States
(12) Patent Application Publication
(10) Pub. No.: US 2014/0366920 A1
(43) Pub. Date: Dec. 18, 2014

(54) USE OF IRON(III) HYDROXYMONOCARBOXYLATE COMPLEXES TO ENHANCE LOWER TEMPERATURE CLEANING IN ALKALINE PEROXIDE CLEANING SYSTEMS

(71) Applicant: ECOALB USA INC., St. Paul, MN (US)

(72) Inventors: Achim Bohme, Duesseldorf (DE); Virginie Maas, Kempen (DE)

(73) Assignee: ECOALB USA INC., St. Paul, MN (US)

(21) Appl. No.: 14/343,200

(22) PCT Filed: Sep. 21, 2011
(86) PCT No.: PCT/EP2011/066389

§ 371 Date: Jun. 25, 2014

(51) Int. Cl. C11D 3/39; C11D 17/00

(52) U.S. Cl. CPC C11D 3/391; C11D 17/0017
USPC 134/26; 510/376

(57) ABSTRACT

The present invention relates to an aqueous composition for removing soil at low temperatures from a surface to be cleaned, comprising a source of alkalinity, a surfactant, an iron(III) activator complex and a source of peroxide. The composition can be used for removing soil from a surface to be cleaned, preferably in a clean-out-of-place systems (COP) or in a clean-in-place system (CIP).

### FIELD OF THE INVENTION

The present invention relates to compositions and methods for removing soils from surfaces, such as hard surfaces, by generating a gas on and in the soil, at reduced temperatures.

### BACKGROUND

In many industrial applications, such as the manufacture of foods and beverages, especially in the meat processing industry, hard surfaces commonly become contaminated with soils such as carbohydrate, proteins, blood and water hardness soils, food oil soils, fat soils and other soils. Such soils can arise from the manufacture of both liquid and solid foodstuffs. Meat soils and residues such as proteins, fats, blood and oils, especially when dried, can be hard to remove soil. Similarly, carbohydrate soils, such as cellulosic, monosaccharides, disaccharides, oligosaccharides, starches, gums and other complex materials, when dried, can form tough, hard to remove soils, particularly when combined with other soil components such as proteins, blood, fats, oils, minerals, and others. The removal of such food soil, such as meat soils and residues, can be a significant problem.

Clean in place (CIP) cleaning techniques are a specific cleaning regimen adapted for removing soils from the internal components of tanks, lines, pumps and other process equipment used for processing typically liquid product streams such as beverages, milk, juices, etc. Clean in place cleaning involves passing cleaning solutions through the system without dismantling any system components. The minimum clean-in-place technique involves passing the cleaning solution through the equipment and then resuming normal processing. Any product contaminated by cleaner residue can be discarded.

Clean out of place systems (COP) cleaning techniques are a specific cleaning regimen adapted for removing soils from interior and exterior surfaces of a wide variety of parts, such as ceramic surfaces, metal surfaces, walls, wash tanks, soaking vessels, mop buckets, holding tanks, scrub sinks, vehicle parts washers, non-continuous batch washers and systems, ceilings, external parts of production machinery and the like.

Often clean in place as well as clean out of place methods can involve a first rinse, the application of the cleaning solutions, and a second rinse with potable water followed by resumed operations. The process can also include any other contacting step in which a rinse, acidic or basic functional fluid, solvent or other cleaning component such as hot water, cold water, etc. can be contacted with the equipment at any step during the process. Conventional clean in place as well as clean out of place methods require high temperatures, e.g., of about 40° C. to about 80° C. In production rooms, the elevated water temperature currently used for that kind of cleaning processes is in the range of about 40° C. to about 60° C. Conventional clean in place techniques (CIP) as well as clean out of place techniques (COP) thus require the consumption of large amounts of energy.

Further cleaning compositions used in clean in place as well as clean out of place processes, in particular in the food and meat processing industry are non-foaming or low foaming liquid compositions. Non foaming or low foaming cleaning compositions have the drawback that the soaking time on an upright tiled wall is short due to a good flow rate of the liquid cleaning composition.

Furthermore, non foaming or low foaming cleaning compositions have the drawback that the user cannot easily track the areas that are processed or not processed due to the brief residence time of the cleaning composition and low foam stability. There is a tendency that surfaces to be cleaned are treated twice thus require the consumption of large amounts of water and cleaning composition.

What is needed therefore is an improved low temperature cleaning composition for removing soils that are not easily removed at reduced temperatures, having an increased dwell time and being traceable.

### SUMMARY OF THE INVENTION

The object addressed by the present invention is to provide a cleaning composition that minimizes energy and having excellent soil removal properties, preferably in the food and meat processing industry.

According to the present invention an aqueous composition for removing soil at low temperatures from a surface to be cleaned is provided, comprising a source of alkalinity, a surfactant, an iron(III) activator complex and a source of peroxide.

In some embodiments, the aqueous composition is an aqueous two-component composition for removing soil at low temperatures from a surface to be cleaned, comprising a component A) and a component B),

wherein the component A) comprises:
a source of alkalinity,
a surfactant,
an iron(III) activator complex, preferably and iron(III) C₄ to C₁₈ hydroxymonocarboxylate activator complex; and

wherein the component B) comprises:
a source of peroxide.

A solvent, preferably water, can be added 100 wt.-% to the cleaning composition of the invention. The solvent content, preferably water, of the cleaning composition according to the invention is simply determined by subtracting the amounts of all the usual components from 100 wt. %.

Generally, in meat production rooms for cleaning processes the elevated water temperature is about 40° C. to 60° C. According to the present invention the water temperature used for pre-rinsing, foaming and final rinse can be adjusted to about ≧10° C. to about ≦20° C., preferably ≧12° C. to about ≦15° C.

The weight amount (wt.-%) is calculated on the total weight amount of the liquid cleaning composition, if not otherwise stated. The total weight amount of all components of the liquid cleaning composition does not exceed 100 wt.-%.

As used herein, “weight percent,” “wt-%,” “percent by weight,” “% by weight,” and variations thereof refer to the concentration of a substance as the weight of that substance divided by the total weight of the composition and multiplied by 100. It is understood that, as used here, “percent,” “%,” and the like are intended to be synonymous with “weight percent,” “wt-%,” etc.

As used herein, the term “about” refers to variation in the numerical quantity that may occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

It should be noted that, as used in this specification and the appended claims, the singular forms “a,” “an,” and “the” include plural referents unless the content clearly dictates otherwise. Thus, for example, reference to a composition containing “a compound” includes a composition having two or more compounds. It should also be noted that the term “or” is generally employed in its sense including “and/or” unless the content clearly dictates otherwise.

As used herein, the term “cleaning” refers to a method or process used to facilitate or aid in soil removal, bleaching, microbial population reduction, and any combination thereof. The methods, and compositions of the present invention can include, consist essentially of, or consist of the steps, and ingredients of the present invention as well as other ingredients described herein.

As used herein, “consisting essentially of” means that the methods, and compositions may include additional steps, or ingredients, but only if the additional steps, or ingredients do not materially alter the basic and novel characteristics of the claimed methods, and compositions.

In some embodiments, the compositions for use with the methods of the present invention are at an alkaline pH, e.g., about 11 to about 14. In some embodiments, all components may be applied to the surface to be cleaned as part of a foam composition. In other embodiments, the components A) comprising the activator complex and the source of alkalinity may be applied to the surface as part of one composition and the active oxygen source of component B) may be applied as part of another separate composition. In still yet other embodiments, the active oxygen source and the activator complex may be applied to the surface as part of one composition, and the source of alkalinity may be applied to the surface as part of another separate composition. The activator complex, the source of alkalinity and the active oxygen source may be applied in any combination, and in any stepwise order, to the surface to be cleaned, whereby the application in form of foam to the surface to be cleaned is most preferred.

A preferred embodiment of the present invention can be a foam composition comprising the mixed components A) and B).

Still another embodiment of the present is directed to a method for removing soil from a surface to be cleaned comprising applying to the surface a composition of the present invention.

It has been surprisingly found that the aqueous composition can be used for removal of soil at reduced temperatures, while still providing excellent soil removal properties. Thus, the compositions of the present invention provide for reduced energy consumption, e.g., lower cleaning temperatures.

The composition of the invention is applied to the surface to be cleaned in the form of foam. The foam has compared to a liquid composition an increased dwell time and the foam treated areas can be easily tracked that avoids multiple treatment of the same area. Thus, the compositions of the present invention provide for reduced water and reduced chemical consumption.

It can be preferred that the aqueous liquid cleaning composition comprises a component A) and a component B) that are separated from each other. At the time of use, a foam of component A) and component B) is generated, which is applied to the surface to be cleaned.

The aqueous cleaning composition of the invention can be a concentrated solution. A concentrated solution has advantages in transporting and storing. The concentrated solution can be further diluted, for example prior use, by admixing a solvent, preferably water.

It should be understood that the aqueous cleaning composition of the invention can be free of at least one additive, preferably all additives, selected from the group of dye, color transfer inhibitor, anti-redeposition agents, optical brighteners, builder, oil and water repellant agents, color fastness agents, starch/sizing agents, fabric softening agents, anti-microbials, fungicides, UV absorbers, thickeners, oxidizers, fragrances and/or mixtures thereof.

### DETAILED DESCRIPTION

In some aspects, the present invention relates to compositions and methods for removing soils from surfaces to be cleaned. Surfaces to be cleaned are hard and/or soft surfaces. In some embodiments, the composition of the invention is applied in a clean in place process (CIP) and/or in a clean out of place process (COP). According to the present invention it is preferred that the clean in place process (CIP) is a fully automated cleaning process that requires no reconstruction of the production plant before execution of the cleaning.

In other embodiments, the compositions of the invention may be manually applied to the surface to be cleaned. In particular the compositions of the invention can be used in the food processing industry, such as meat processing industry, for cleaning purposes.

The composition of the invention can be a two component composition that can be mixed in situ. The mixed composition can be shelf stable for about 30 minutes to about 60 minutes. The compositions of the invention can be applied to the surfaces to be cleaned in form of a foam. Applying a foam to an upright surface to be cleaned provides a prolonged contact time and the treated areas can be easily traced. The foam stability may be in the range of about 10 minutes to about 20 minutes.

The cleaning methods and compositions may be used at lower temperatures than those used in conventional cleaning methods. The compositions of the invention are activated for example by contact with an iron(III) activator complex. Without wishing to be bound by any particular theory, it is thought that the use of the selected activator complexes allows for the lowering of the cleaning temperature. It is thought that the activator complexes act as a catalyst for the active oxygen source to produce oxygen gas at lower temperatures than those temperatures at which the active oxygen source conventionally degrades to produce oxygen gas. In some embodiments, the use of an iron(III) activator complex in combination with an active oxygen source allows for the production of oxygen gas in situ on and in a soil, and/or in solution. It is thought that the mechanical action of the oxygen gas generation aids in breaking up soils present on the contacted surfaces.

In some embodiments, the use of an iron(III) activator complex in the methods of the present invention allows for the use of reduced levels of chemistry, e.g., an alkaline source and/or an active oxygen source, during cleaning, because the cleaning composition of the invention has a remarkable increased cleaning efficiency that allows the use of a lower concentrated cleaning composition. Thus, the methods of the present invention provide for reduced energy consumption, e.g., lower cleaning temperatures, and reduced chemical consumption.

In some embodiments, the compositions of the invention including the foam can have an alkaline pH, e.g., a pH of about 10 to about 14.

To prevent the decomposition of the activator complex to an inactive form, e.g., iron (II) or other inactive forms, the compositions of the present invention may include builders and/or additional chelating agents. Builders and/or chelating agents may be used to keep an active form on the activator complex in solution/suspension. This aids in providing suitable activity for reuse of the solutions as well.

The methods, and compositions of the present invention can include, consist essentially of, or consist of the steps, and ingredients of the present invention as well as other ingredients described herein. As used herein, “consisting essentially of” means that the methods, and compositions may include additional steps, or ingredients, but only if the additional steps, or ingredients do not materially alter the basic and novel characteristics of the claimed methods, and compositions.

In some aspects, the methods and compositions of the present invention may be applied to equipment generally cleaned using clean in place cleaning procedures. Examples of such equipment include evaporators, heat exchangers (including tube-in-tube exchangers, direct steam injection, and plate-in-frame exchangers), heating coils (including steam, flame or heat transfer fluid heated) re-crystallizers, pan crystallizers, spray dryers, drum dryers, and tanks.

The methods and compositions of the present invention may be used in any application where thermally degraded soils, i.e., caked on soils or burned on soils, such as proteins or carbohydrates, need to be removed. As used herein, the term “thermally degraded soil” refers to a soil or soils that have been exposed to heat and as a result have become baked on to the surface to be cleaned. Exemplary thermally degraded soils include food soils that have been heated during processing, e.g., dairy products heated on pasteurizers, fructose, or corn syrup.

The methods and compositions of the present invention may also be used to remove other non-thermally degraded soils that are not easily removed using conventional cleaning techniques. Soil types suited to cleaning with the methods of the present invention include, but are not limited to, starch, cellulosic fiber, protein, simple carbohydrates and combinations of any of these soil types with mineral complexes. Examples of specific food soils that are effectively removed using the methods of the present invention include, but are not limited to, meat residues, blood residues, protein residues, vegetable and fruit juices, brewing and fermentation residues, soils generated in sugar beet and cane processing, and soils generated in condiment and sauce manufacture, e.g., ketchup, tomato sauce, barbeque sauce. These soils can develop on heat exchange equipment surfaces and on other surfaces during the manufacturing and packaging process.

Exemplary industries in which the methods and compositions of the present invention can be used include, but are not limited to: the food and beverage industry, e.g., the meat processing industry; dairy, cheese, sugar, and brewery industries; oil processing industry; industrial agriculture and ethanol processing; and the pharmaceutical manufacturing industry.

Conventional CIP as well as COP processing is generally well-known. The process includes applying a foam composition of the invention onto the surface to be cleaned. The foam adheres on the surface for slowly removing the soil.

The process to remove a soil according to the invention can includes an alkaline foam wash. According to one embodiment of the invention a process to remove a soil can include a fresh water rinse and an alkaline foam wash or a fresh water rinse, an alkaline foam wash and a fresh water rinse. Another embodiment of a process of the invention to remove soil can comprise at least three steps: an alkaline foam wash, an acid solution wash, and then a fresh water rinse. The alkaline foam softens the soils and removes the organic alkaline soluble soils. The subsequent acid solution removes mineral soils left behind by the alkaline cleaning step. The strength of the alkaline and acid solutions and the duration of the cleaning steps are typically dependent on the durability of the soil. The water rinse removes any residual solution and soils, and cleans the surface prior to the equipment being returned on-line.

The methods and compositions of the present invention provide for enhanced soil removal at reduced temperatures, e.g., about ≧10° C. to ≦20° C., preferably at about 15° C. The present invention also provides for a reduction in the amount of chemistry and water consumed during the cleaning process. Thus, the present invention provides both energy and water savings, while achieving effective soil removal.

The composition of the invention can be applied by spray as foam to the surface to be cleaned. By “spray” the present invention means a spray of discrete droplets or a jet of foam. The operative consideration being that one or preferably both of the components A) and B) compositions are ejected from the unit with sufficient force that can be deposited upon a surface that is displaced horizontally from the unit.

The process for making the foam according to the invention may involve the use of a foam cleaning device, comprising a double injection system. This system enables the mixing of component A) and component B) with water by means of the Venturi Principle, followed by the addition of compressed air to produce foam. Using the double injection system described above components A) and B) are diluted on-line, with water under pressure at the time of application, to a concentration of between 0.1 and 10 wt.-%, preferably 0.1 to 5 wt.-%, and most preferably 0.5 and 3 wt.-%.

According to one embodiment, the foam composition of the invention has a foam stability, wherein the reduction of foam volume after 1 minute is about 10 vol.-% to 20 vol.-%, after 2 minute is about 15 vol.-% to 25 vol.-%, after 5 minute is about 30 vol.-% to 40 vol.-% and after 10 minute is about 75 vol.-% to 85 vol.-%, based on the initial foam volume.

The foam stability allows an improved cleaning effect, because the foam as such can be considered as a carrier for the cleaning solution. It ensures that the solution can also adhere to vertical surface and ceilings. As a result, longer contact is achieved between the cleaning solution and the surface to be cleaned. The foam layer on the cleaning agent film has a repository effect, i.e. through destruction of further foam bubbles new cleaning agent solution is constantly transported to the surface.

According to one preferred embodiment, the foam composition of the invention having a mean foam pore size D₅₀ in the range of ≧10 μm to about ≦2000 μm, preferably ≧80 μm to about ≦1000 μm, and more preferred ≧100 μm to about ≦500 μm.

The increased foam stability and foam pore size of the foamed composition according to the present invention provides beside the improved cleaning activity of the selected components an additional increase of the cleaning effect.

The aqueous composition for removing soil at low temperatures from a surface to be cleaned, comprising a source of alkalinity, a surfactant, an iron(III) C₄ to C₁₈ hydroxymonocarboxylate activator complex and a source of peroxide provides excellent soil removal properties. Low temperatures are temperatures at between about ≧1° C. to about ≦30° C., preferably at between about ≧5° C. to about ≦25° C., further preferred at between about ≧7° C. to about ≦20° C. and more preferred about ≧10° C. to about ≦15° C. The composition of the invention can be used at low temperatures in form of foam cleaner in order to change the current cleaning process for example in the meat processing industry. The benefit of the use of the composition of the invention is a decrease of the water temperature used for pre-rinsing, foaming and final rinse.

A preferred embodiment of the present invention is an aqueous two component composition for removing soil at low temperatures from a surface to be cleaned, comprising a component A) and a component B), wherein the component A) comprises at least one source of alkalinity, at least one surfactant, at least one iron(III) C₄ to C₁₈ hydroxymonocarboxylate activator complex; and wherein the component B) comprises at least one source of peroxide.

An improved cold cleaning performance at temperatures about ≦20° C., preferably at about ≦15° C., can be obtained by choosing the mol ratio of iron(III) to C₄ to C₁₈ hydroxymonocarboxylate is about 1:>1, preferably in the range of about 1:1.1 to 1:10, further preferred in the range of about 1:1.5 to 1:8 and more preferred in the range of about 1:2 to 1:5.

The present invention provides an aqueous composition including an iron(III) activator complex. As used herein the term “activator complex” or “activation complex” refers to an iron(III) activator complex capable of reacting with an active oxygen source and/or a soil to enhance production of oxygen gas in situ on and in the soil. Without wishing to be bound by any particular theory, it is thought that the iron(III) activator complex acts as a catalyst for oxygen gas generation during cleaning. That is, it is thought that the iron(III) activator complex degrades an active oxygen source to generate oxygen gas in situ on and in the soil, during cleaning, without being degraded itself.

Additional methods for enhancing the alkaline stability of an iron(III) activator complex include, but are not limited to, encapsulating the activator complex.

Without wishing to be bound by any particular theory, it is thought that the iron(III) activator complexes facilitate and enhance the ability of the compositions to clean surfaces at reduced temperatures, e.g., between about 5° C. and about 20° C. That is, the use of an iron(III) activator complex allows for oxygen gas production on and in the soil to be removed without the use of elevated temperatures. Further, the iron(III) activator complex aids in the production of oxygen gas at an alkaline pH.

Such oxygen production aids in facilitating soil removal by generating mechanical action on and in the soil, in addition to the normal bleaching and cleaning action of an oxygen producing source. It is thought that the active oxygen source penetrates the soil. When the active oxygen source within the soil is contacted by the iron(III) activator complex, oxygen gas is produced within the soil. As the oxygen gas is being produced, it breaks up the soil from within. As an aqueous solution, preferably foam, is passed over or through the surface, the broken up soil is washed away.

Without wishing to be bound by any particular theory, it is thought that foam compositions including iron(III) activator complexes and active oxygen sources are also activated upon contact with a soil. That is, although some bubbling and gas generation may occur when an iron(III) activator complex contacts an active oxygen source, when the compositions including an iron(III) activator complex and an active oxygen source contact a soil the amount of bubbling and oxygen gas generated substantially increases. This increased gas generation upon contact with a soil may be due in part to the soil providing nucleation sites for the active oxygen source and/or the iron(III) activator complex. It may also be due to the presence of electrons in the soil, which may cause the iron(III) activator complex to act as a catalyst and recycle itself.

The amount of iron(III) activator complex used in the methods of the present invention is dependent on a variety of factors including, the active oxygen source used, the type of surface to be cleaned, and the amount and type of soil present on the surface. The amount of iron(III) activator complex used is also dependent on the size of the particular iron(III) activator complex chosen.

In some embodiments, the compositions of the present invention include about 0.0001 wt.-% to about 1.0 wt.-% of the iron(III) activator complex, based on total weight of the cleaning composition. In other embodiments, the amount of iron(III) activator complex present is about 0.1 wt.-% to about 5 wt.-% of the compositions of the present invention. Acceptable levels of iron(III) activator complex include about 0.0005 wt.-% to about 0.002 wt.-%, or about 0.005 wt.-% to about 0.02 wt.-%; 0.01 wt.-% is a particularly suitable level.

In some embodiments, the amount of iron(III) activator complex added may be such that the production of oxygen from the reaction between the iron(III) activator complex and the active oxygen source is controlled over time. This is particularly desirable when cleaning surfaces using a clean out of place (COP) and/or clean in place (CIP) method so as to not damage the surface or the equipment to be cleaned due to large amounts of oxygen gas production. In some embodiments, the concentration of the activator complex added is varied to provide a controlled release of oxygen gas on the surface to be cleaned.

In some embodiments, the reaction rate between the activator complex, and the active oxygen source, and/or the soil, may be controlled. Certain compounds and compositions may be used to increase the activity of the iron(III) activator complex, e.g., increase the amount of oxygen gas generated. Certain compounds and compositions may also be used to reduce the activity of the iron(III) activator complex, e.g., decrease the amount of oxygen gas generated. Exemplary activity reducers include, for example, ethylenedinitrilotetraacetic acid (EDTA).

In some embodiments of the present invention the composition comprises:
≧5 wt.-% to about ≦70 wt.-%, preferably ≧10 wt.-% to about ≦60 wt.-%, and more preferred ≧20 wt.-% to about ≦50 wt.-%, of the source of alkalinity, preferably sodium hydroxide;
≧0.01 wt.-% to about ≦30 wt.-%, preferably ≧0.1 wt.-% to about ≦20 wt.-%, and more preferred ≧0.5 wt.-% to about ≦15 wt.-%, of a surfactant;
≧0.001 wt.-% to about ≦10 wt.-%, preferably ≧0.01 wt.-% to about ≦5 wt.-%, and more preferred ≧0.1 wt.-% to about ≦3 wt.-%, of an iron(III) C₄ to C₁₈ hydroxymonocarboxylate activator complex, preferably an iron(III) gluconate activator complex;
≧10 wt.-% to about ≦80 wt.-%, preferably ≧20 wt.-% to about ≦70 wt.-%, and more preferred ≧30 wt.-% to about ≦50 wt.-%, of a solvent, preferably water;
≧5 wt.-% to about ≦70 wt.-%, preferably ≧10 wt.-% to about ≦60 wt.-%, and more preferred ≧15 wt.-% to about ≦40 wt.-%, of a source of peroxide, preferably hydrogen peroxide;

≧10 wt.-% to about ≦80 wt.-%, preferably ≧20 wt.-% to about ≦70 wt.-%, and more preferred ≧30 wt.-% to about ≦60 wt.-%, of a solvent, preferably water; wherein the weight % of the components are based on the total weight of the composition and the total wt.-% of all components of the composition does not exceed 100 wt.-%.

The composition of the present invention can be applied on the surface to be cleaned in form of a foam. The foam comprises the mixed components of the aqueous composition of the invention.

According to a preferred embodiment, the foam provides adhesive properties.

According to a further embodiment, the foam has a small pore size. Preferably, the pore size D₅₀ is in the range of about ≧10 μm to about ≦2000 μm, preferably ≧80 μm to about ≦1000 μm, and more preferred ≧100 μm to about ≦500 μm.

D₅₀ means that 50% of the total foam pores are in the defined range pore size.

Complexing Agents

The transition metal complex includes an iron(III) ions and an alkaline stable complexing agent. Exemplary sources of iron(III) ions for use in preparing an alkaline stable transition metal complex include, but are not limited to, iron (III) sulfate, iron(III) chloride, iron (III) oxide, iron (III) acetate, iron(III) gluconate, iron(III) nitrate and combinations thereof. Exemplary alkaline stable complexing agents include, but are not limited to sodium C₄ to C₁₈ hydroxymonocarboxylates, gluconate, sorbitol, mannitol, tartrate, sucrose, erythritol, inositol and combinations thereof. Suitable C₄ to C₁₈ hydroxymonocarboxylates for use can be selected from the group comprising citrate; propionate; gluconate; glycolate; glucoheptanoate; succinate; lactate; methyllactate; 2-hydroxybutanoate; mandelate; atrolactate; phenyllactate; glyerate; 2,3,4-trihydroxybutanoate; alpha hydroxylaurate; benzillate; isocitrate; citramalate; agaricate; quinate; uronates, including glucuronate, glucuronolactonate, galaturonate, galacturonolactonate; hydroxypyruvate; ascorbate; and/or tropate. However, most preferred can be gluconate.

Active Oxygen Source

In some embodiments, the compositions of the present invention include an active oxygen source. As used herein, the term “active oxygen source,” refers to any composition capable of generating oxygen gas in situ on and in a soil, as well as in solution. In some embodiments, the active oxygen source is a compound capable of providing oxygen gas in situ on and in the soil upon contact with an iron(III) activator complex. The compound may be organic, or inorganic.

Exemplary active oxygen sources for use in the methods of the present invention include, but are not limited to, peroxygen compounds, bromates, iodates, permanganates, perborates, and gaseous oxidants such as ozone, oxygen, chlorine dioxide, sulfur dioxide and derivatives thereof. In some embodiments, the active oxygen source does not include a chlorine containing group. Without wishing to be bound by any particular theory, it is thought that reaction of the active oxygen source with the soil and/or the activator complex creates vigorous mechanical action on and within the soil due to the oxygen gas released. The mechanical action may break up the soil from within. It is thought that this mechanical action enhances removal of the soil beyond that caused by the chemical and bleaching action of the active oxygen source alone.

In some embodiments, the active oxygen source includes at least one peroxygen compound. Peroxygen compounds including, but not limited to, peroxides and various percarboxylic acids, including percarbonates, may be used in the methods of the present invention. Peroxycarboxylic (or percarboxylic) acids generally have the formula R(CO₃H)ₙ, where, for example, R is an alkyl, arylalkyl, cycloalkyl, aromatic, or heterocyclic group, and n is one, two, or three, and named by prefixing the parent acid with peroxy. The R group may be saturated or unsaturated as well as substituted or unsubstituted. Medium chain peroxycarboxylic (or percarboxylic) acids may have the formula R(CO₃H)ₙ, where R is a C₅-C₁₁ alkyl group, a C₅-C₁₁ cycloalkyl, a C₅-C₁₁ arylalkyl group, C₅-C₁₁ aryl group, or a C₅-C₁₁ heterocyclic group; and n is one, two, or three. Short chain perfatty acids may have the formula R(CO₃H)ₙ where R is C₁-C₄ and n is one, two, or three.

Exemplary peroxycarboxylic acids for use with the present invention include, but are not limited to, peroxypentanoic, peroxyhexanoic, peroxyheptanoic, peroxyoctanoic, peroxynonanoic, peroxyisononanoic, peroxydecanoic, peroxyundecanoic, peroxydodecanoic, peroxyascorbic, peroxyadipic, peroxycitric, peroxypimelic, or peroxysuberic acid, and mixtures thereof.

Branched chain peroxycarboxylic acids include peroxyisopentanoic, peroxyisononanoic, peroxyisohexanoic, peroxyisoheptanoic, peroxyisooctanoic, peroxyisonananoic, peroxyisodecanoic, peroxyisoundecanoic, peroxyisododecanoic, peroxyneopentanoic, peroxyneohexanoic, peroxyneoheptanoic, peroxyneooctanoic, peroxyneononanoic, peroxyneodecanoic, peroxyneoundecanoic, peroxyneododecanoic, and mixtures thereof.

Additional exemplary peroxygen compounds for use with the methods of the present invention include hydrogen peroxide (H₂O₂), peracetic acid, peroctanoic acid, a persulphate, a perborate, or a percarbonate. In some embodiments, the active oxygen source includes hydrogen peroxide.

In some embodiments, compositions for use in the methods of the present invention include at least one active oxygen source. In other embodiments, compositions for use in the methods of the present invention include at least two, at least three, or at least four active oxygen sources. For example, combinations of active oxygen sources for use with the methods of the present invention may include, but are not limited to, peroxide/peracid combinations, or peracid/peracid combinations. In other embodiments, the active oxygen use source includes a peroxide/acid or a peracid/acid composition.

Active oxygen sources include commercially available active oxygen sources and/or active oxygen sources that may be generated on site. Active oxygen sources may also be generated in situ. That is, in some embodiments, active oxygen sources may be generated directly in the compositions of the present invention. For example, peroxidases and other enzymes, e.g., those found within peroxizomes, may be included in the compositions of the present invention. For example, D-amino oxidases such as glucose oxidase readily utilize oxygen to convert D-glucose into gluconic acid and hydrogen peroxide. In some embodiments of the present invention, enzymes capable of converting sugars in the system into hydrogen peroxide can be included. The hydrogen peroxide produced may then generate oxygen gas when contacted with the activator complex. In yet other embodiments, enzymes such as the superoxide dismutases may be used to convert the superoxide anion into hydrogen peroxide and oxygen.

According to the present invention the source of peroxide can be preferably selected from the group comprising hydrogen peroxide, peracetic acid, peroctanoic acid, a persulphate, a perborate, a percarbonate and mixtures and derivatives thereof, preferably hydrogen peroxide, peracetic acid, peroctanoic acid and mixtures and derivatives thereof. However, most preferred is hydrogen peroxide.

The amount of active oxygen source present in the compositions of the present invention is dependent on a variety of factors including, for example, the type of surface to be cleaned, and the amount and type of soil present on the surface. In some embodiments, the amount of active oxygen source present is between about ≧5 wt.-% and about ≦70 wt.-%. Acceptable levels of active oxygen source present are ≧10 wt.-% and about ≦60 wt.-%, or ≧15 wt.-% and about ≦50 wt.-%; ≧20 wt.-% and about ≦40 wt.-% is a particularly suitable level.

Alkalinity Source

In some aspects, the compositions of the present invention include a source of alkalinity. Exemplary alkaline sources suitable for use with the present invention include, but are not limited to, basic salts, amines, alkanol amines, carbonates and silicates, and mixtures thereof. Other exemplary alkaline sources for use with the methods of the present invention include NaOH (sodium hydroxide), KOH (potassium hydroxide), TEA (triethanol amine), DEA (diethanol amine), MEA (monoethanolamine), sodium carbonate, and morpholine, sodium metasilicate and potassium silicate. The alkaline source selected may be compatible with the surface to be cleaned. Preferably, the source of alkalinity is selected from the group comprising sodium hydroxide, potassium hydroxide or a mixture thereof, most preferred is sodium hydroxide.

The amount of alkaline source present is dependent on a variety of factors including, for example, the type of surface to be cleaned, and the amount and type of soil present on the surface. In some embodiments, the amount of alkaline source present is about 5 wt.-% to about 70 wt.-%. Suitable levels of alkaline include about 10 wt.-% to about 60 wt.-% and about 20 wt.-% to about 50 wt.-%.

Surfactants

A surfactant or mixture of surfactants may be used in the methods of the present invention. The surfactant chosen may be compatible with the surface to be cleaned. A variety of surfactants may be used, including anionic, nonionic, cationic, and zwitterionic surfactants, which are commercially available from a number of sources. Suitable surfactants include nonionic surfactants, for example, low foaming non-ionic surfactants. For a discussion of surfactants, see Kirk-Othmer, Encyclopedia of Chemical Technology, Third Edition, volume 8, pages 900-912.

According to the present invention the surfactant can be preferably selected from the group comprising anionic surfactant and/or non-ionic surfactant. It can be preferred that the surfactant is selected from the group comprising of linear alkyl benzene sulfonates, alcohol sulfonates, amine oxides, alcohol ethoxylates, alkyl phenol ethoxylates, polyethylene glycol esters, EO/PO block copolymers, and mixtures thereof.

In addition, the level and degree of foaming under the conditions of use and in subsequent recovery of the composition may be a factor for selecting particular surfactants and mixtures of surfactants. For example, in certain applications it may be desirable to minimize foaming and a surfactant or mixture of surfactants that provides reduced foaming may be used. In addition, it may be desirable to select a surfactant or a mixture of surfactants that exhibits a foam that breaks down relatively quickly so that the composition may be recovered and reused with an acceptable amount of down time. In addition, the surfactant or mixture of surfactants may be selected depending upon the particular soil that is to be removed.

The surfactants described herein may be used singly or in combination in the methods of the present invention. In particular, the nonionics and anionics may be used in combination. The semi-polar nonionic, cationic, amphoteric and zwitterionic surfactants may be employed in combination with nonionics or anionics. The above examples are merely specific illustrations of the numerous surfactants which may find application within the scope of this invention. It should be understood that the selection of particular surfactants or combinations of surfactants may be based on a number of factors including compatibility with the surface to be cleaned at the intended use concentration and the intended environmental conditions including temperature and pH.

In some embodiments, the amount of total surfactant in the compositions is ≧0.01 wt.-% to about ≦30 wt.-%. Acceptable levels of surfactant include ≧0.1 wt.-% to about ≦20 wt.-%, or ≧0.5 wt.-% to about ≦15 wt.-%.

Nonionic Surfactants

Nonionic surfactants suitable for use in the composition of the present invention include, but are not limited to, those having a polyalkylene oxide polymer as a portion of the surfactant molecule. Exemplary nonionic surfactants include, but are not limited to, chlorine-, benzyl-, methyl-, ethyl-, propyl-, butyl- and other like alkyl-capped polyethylene and/or polypropylene glycol ethers of fatty alcohols; polyalkylene oxide free nonionics such as alkyl polyglycosides; sorbitan and sucrose esters and their ethoxylates; alkoxylated ethylene diamine; carboxylic acid esters such as glycerol esters, polyoxyethylene esters, ethoxylated and glycol esters of fatty acids; carboxylic amides such as diethanolamine condensates, monoalkanolamine condensates, polyoxyethylene fatty acid amides; and ethoxylated amines and ether amines commercially available from Tomah Corporation and other like nonionic compounds. Silicone surfactants such as the ABIL B8852 (Goldschmidt) may also be used.

Additional exemplary nonionic surfactants suitable for use in the methods of the present invention, include, but are not limited to, those having a polyalkylene oxide polymer portion include nonionic surfactants of C6-C24 alcohol ethoxylates, preferably C6-C14 alcohol ethoxylates having 1 to about 20 ethylene oxide groups, preferably about 9 to about 20 ethylene oxide groups; C6-C24 alkylphenol ethoxylates, preferably C8-C10 alkylphenol ethoxylates) having 1 to about 100 ethylene oxide groups, preferably about 12 to about 20 ethylene oxide groups; C6-C24 alkylpolyglycosides, preferably C6-C20 alkylpolyglycosides, having 1 to about 20 glycoside groups, preferably about 9 to about 20 glycoside groups; C6-C24 fatty acid ester ethoxylates, propoxylates or glycerides; and C4-C24 mono or dialkanolamides.

Exemplary alcohol alkoxylates include, but are not limited to, alcohol ethoxylate propoxylates, alcohol propoxylates, alcohol propoxylate ethoxylate propoxylates, alcohol ethoxylate butoxylates; nonylphenol ethoxylate, polyoxyethylene glycol ethers; and polyalkylene oxide block copolymers including an ethylene oxide/propylene oxide block copolymer such as those commercially available under the trademark PLURONIC (BASF-Wyandotte).

Examples of suitable low foaming nonionic surfactants also include, but are not limited to, secondary ethoxylates, such as those sold under the trade name TERGITOL™, such as TERGITOL™ 15-S-7 (Union Carbide), Tergitol 15-S-3, Tergitol 15-S-9 and the like. Other suitable classes of low foaming nonionic surfactants include alkyl or benzyl-capped polyoxyalkylene derivatives and polyoxyethylene/polyoxypropylene copolymers.

An additional useful nonionic surfactant is nonylphenol having an average of 12 moles of ethylene oxide condensed thereon, it being end capped with a hydrophobic portion including an average of 30 moles of propylene oxide. Silicon-containing defoamers are also well-known and may be employed in the methods of the present invention.

In some embodiments, the amount of nonionic surfactant in the compositions is ≧0.01 wt.-% to about ≦30 wt.-%. Acceptable levels of surfactant include ≧0.1 wt.-% to about ≦20 wt.-%, or ≧0.5 wt.-% to about ≦15 wt.-%.

Amphoteric Surfactants

Suitable amphoteric surfactants include, but are not limited to, amine oxide compounds having the formula:

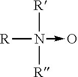

where R, R′, R″, and R′″ are each a C₁-C₂₄ alkyl, aryl or arylalkyl group that may optionally contain one or more P, O, S or N heteroatoms.

Another class of suitable amphoteric surfactants includes betaine compounds having the formula:

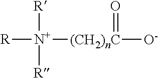

where R, R′, R″ and R′″ are each a C₁-C₂₄ alkyl, aryl or aralkyl group that may optionally contain one or more P, O, S or N heteroatoms, and n is about 1 to about 10.

Suitable surfactants may also include food grade surfactants, linear alkylbenzene sulfonic acids and their salts, and ethylene oxide/propylene oxide derivatives sold under the Pluronic™ trade name. Suitable surfactants include those that are compatible as an indirect or direct food additive or substance.

In some embodiments, the amount of amphoteric surfactant in the compositions is ≧0.01 wt.-% to about ≦30 wt.-%. Acceptable levels of surfactant include ≧0.1 wt.-% to about ≦20 wt.-%, or ≧0.5 wt.-% to about ≦15 wt.-%.

Anionic Surfactants

Anionic surfactants suitable for use with the disclosed methods may also include, for example, carboxylates such as alkylcarboxylates (carboxylic acid salts) and polyalkoxycarboxylates, alcohol ethoxylate carboxylates, nonylphenol ethoxylate carboxylates, and the like; sulfonates such as alkylsulfonates, alkylbenzenesulfonates, alkylarylsulfonates, sulfonated fatty acid esters, and the like; sulfates such as sulfated alcohols, sulfated alcohol ethoxylates, sulfated alkylphenols, alkylsulfates, sulfosuccinates, alkylether sulfates, and the like; and phosphate esters such as alkylphosphate esters, and the like. Exemplary anionics include, but are not limited to, sodium alkylarylsulfonate, alpha-olefin sulfonate, and fatty alcohol sulfates. Examples of suitable anionic surfactants include sodium dodecylbenzene sulfonic acid, potassium laureth-7 sulfate, and sodium tetradecenyl sulfonate.

In some embodiments, the surfactant includes linear alkyl benzene sulfonates, alcohol sulfonates, amine oxides, linear and branched alcohol ethoxylates, alkyl polyglucosides, alkyl phenol ethoxylates, polyethylene glycol esters, EO/PO block copolymers and combinations thereof.

In some embodiments, the amount of anionic surfactant in the compositions is ≧0.1 wt.-% to about ≦30 wt.-%. Acceptable levels of surfactant include ≧0.5 wt.-% to about ≦20 wt.-%, or ≧1 wt.-% to about ≦15 wt.-%.

Additional Components

Exemplary additional components that may be provided within the compositions used in the methods of the present invention include builders, water conditioning agents, non-aqueous components, adjuvants, carriers, processing aids, enzymes, penetrants, antimicrobial agents, buffers, and pH adjusting agents.

Builders

In some embodiments, compositions for use with the methods of the present invention include a builder or builders. Builders include chelating agents (chelators), sequestering agents (sequestrants), detergent builders, and the like. The builder often stabilizes the composition or solution. In some embodiments, builders suitable for use with the methods of the present invention preferably do not complex with the activator complex. That is, the builder or builders for use with the present invention are selected such that they preferentially complex with the mineral soil broken up after the oxygen gas has been generated in situ on and in the soil, rather than with the activator complex.

Builders and builder salts may be inorganic or organic. Examples of builders suitable for use with the methods of the present invention include, but are not limited to, phosphonic acids and phosphonates, phosphates, aminocarboxylates and their derivatives, pyrophosphates, polyphosphates, ethylenediamene and ethylenetriamene derivatives, hydroxyacids, and mono-, di-, and tri-carboxylates and their corresponding acids. Other builders include aluminosilicates, nitroloacetates and their derivatives, and mixtures thereof. Still other builders include aminocarboxylates, including salts of hydroxyethylenediamine-tetraacetic acid (HEDTA), and diethylenetriaminepentaacetic acid.

Exemplary commercially available chelating agents for use with the methods of the present invention include, but are not limited to: sodium tripolyphosphate available from Innophos; Trilon A® available from BASF; Versene 100®, Low NTA Versene®, Versene Powder®, and Versenol 120® all available from Dow; Dissolvine D-40 available from BASF; and sodium citrate.

In some embodiments, a biodegradable aminocarboxylate or derivative thereof is present as a builder in the methods of the present invention. Exemplary biodegradable aminocarboxylates include, but are not limited to: Dissolvine GL-38® and Dissolvine GL-74® both available from Akzo; Trilon M® available from BASF; Baypure CX100® available from Bayer; Versene EDG® available from Dow; HIDS® available from Nippon Shakubai; Octaquest E30® and Octaquest A65® both available from Finetex/Innospec Octel.

In some embodiments, an organic chelating agent may be used. Organic chelating agents include both polymeric and small molecule chelating agents. Organic small molecule chelating agents are typically organocarboxylate compounds or organophosphate chelating agents. Polymeric chelating agents commonly include polyanionic compositions such as polyacrylic acid compounds. Small molecule organic chelating agents include N-hydroxy-ethylenediaminetriacetic acid (HEDTA), ethylenediaminetetraacetic acid (EDTA), nitrilo-triaacetic acid (NTA), diethylenetriaminepentaacetic acid (DTPA), ethylenediamine-tetraproprionic acid triethylenetetraaminehexaacetic acid (TTHA), and the respective alkali metal, ammonium and substituted ammonium salts thereof. Aminophosphonates are also suitable for use as chelating agents with the methods of the invention and include ethylenediaminetetramethylene phosphonates, nitrilotrismethylene phosphonates, and diethylenetriamine-(pentamethylene phosphonate) for example. These aminophosphonates commonly contain alkyl or alkenyl groups with less than 8 carbon atoms.

Other suitable sequestrants include water soluble polycarboxylate polymers. Such homopolymeric and copolymeric chelating agents include polymeric compositions with pendant (—CO₂H) carboxylic acid groups and include polyacrylic acid, polymethacrylic acid, polymaleic acid, acrylic acid-methacrylic acid copolymers, acrylic-maleic copolymers, hydrolyzed polyacrylamide, hydrolyzed methacrylamide, hydrolyzed acrylamide-methacrylamide copolymers, hydrolyzed polyacrylonitrile, hydrolyzed polymethacrylonitrile, hydrolyzed acrylonitrile methacrylonitrile copolymers, or mixtures thereof. Water soluble salts or partial salts of these polymers or copolymers such as their respective alkali metal (for example, sodium or potassium) or ammonium salts may also be used. The weight average molecular weight of the polymers is from about 4000 to about 12,000. Preferred polymers include polyacrylic acid, the partial sodium salts of polyacrylic acid or sodium polyacrylate having an average molecular weight within the range of 4000 to 8000.

Preferred builders for use with the methods of the present invention are water soluble. Water soluble inorganic alkaline builder salts which may be used alone or in admixture with other builders include, but are not limited to, alkali metal or ammonia or substituted ammonium salts of carbonates, silicates, phosphates and polyphosphates, and borates. Water soluble organic alkaline builders which are useful in the present invention include alkanolamines and cyclic amines.

Particularly preferred builders include PAA (polyacrylic acid) and its salts, phosphonobutane carboxylic acid, EDTA and sodium gluconate.

In some embodiments, the amount of builder present in the compositions for use with the methods of the present invention is about 0.001 wt.-% to about 30 wt.-%. In some embodiments, about 0.005 wt.-% to about 20 wt.-% of builder is present. Acceptable levels of builder include about 0.05 wt.-% to about 15 wt.-%.

Optional Adjuvants

In addition, various other additives or adjuvants may be present in compositions of the present invention to provide additional desired properties, either of form, functional or aesthetic nature, for example:

a) Solubilizing intermediaries called hydrotropes may be present in the compositions of the invention of such as xylene-, toluene-, or cumene sulfonate; or n-octane sulfonate; or their sodium-, potassium- or ammonium salts or as salts of organic ammonium bases. Also commonly used are polyols containing only carbon, hydrogen and oxygen atoms. They preferably contain from about 2 to about 6 carbon atoms and from about 2 to about 6 hydroxy groups. Examples include 1,2-propanediol, 1,2-butanediol, hexylene glycol, glycerol, sorbitol, mannitol, and glucose.

b) Nonaqueous liquid carriers or solvents may be used for varying compositions of the present invention.

c) Viscosity modifiers may be added to the compositions of the present invention. These may include natural polysaccharides such as xanthan gum, carrageenan and the like; or cellulosic type thickeners such as carboxymethyl cellulose, and hydroxymethyl-, hydroxyethyl-, and hydroxypropyl cellulose; or, polycarboxylate thickeners such as high molecular weight polyacrylates or carboxyvinyl polymers and copolymers; or, naturally occurring and synthetic clays; and finely divided fumed or precipitated silica, to list a few. In some embodiments, the compositions for use with the methods of the present invention do not include a gelling agent.

d) Solidifiers may be used to prepare solid forms of compositions of the present invention. These could include any organic or inorganic solid compound having a neutral inert character or making a functional, stabilizing or detersive contribution to the intended embodiment. Examples are polyethylene glycols or polypropylene glycols having molecular weight of from about 1,400 to about 30,000; and urea.

Penetrants

In some aspects, a penetrant may be used with the methods of the present invention. The penetrant may be combined with an alkaline source in the cleaning composition, or, the penetrant may be used without an alkaline source. In some embodiments, the penetrant is water miscible.

Examples of suitable penetrants include, but are not limited to, alcohols, short chain ethoxylated alcohols and phenol (having 1-6 ethoxylate groups). Organic solvents are also suitable penetrants. Examples of suitable organic solvents, for use as a penetrant, include esters, ethers, ketones, amines, and nitrated and chlorinated hydrocarbons.

Ethoxylated alcohols are also suitable for use with the methods of the present invention. Examples of ethoxylated alcohols include, but are not limited to, alky, aryl, and alkylaryl alkloxylates. These alkloxylates may be further modified by capping with chlorine-, bromine-, benzyl-, methyl-, ethyl-, propyl-, butyl- and alkyl-groups. Ethoxylated alcohols may be present in the cleaning composition from about 0.1 wt % to about 20 wt %.

Fatty acids are also suitable for use as penetrants in the methods of the present invention. Some non-limiting examples of fatty acids are C₆ to C₁₂ straight or branched fatty acids. In some embodiments, fatty acids used in the methods of the present invention are liquid at room temperature.

In some embodiments, a penetrant for use in the methods of the present invention includes water soluble glycol ethers. Examples of glycol ethers include dipropylene glycol methyl ether (available under the trade designation DOWANOL DPM from Dow Chemical Co.), diethylene glycol methyl ether (available under the trade designation DOWANOL DM from Dow Chemical Co.), propylene glycol methyl ether (available under the trade designation DOWANOL PM from Dow Chemical Co.), and ethylene glycol monobutyl ether (available under the trade designation DOWANOL EB from Dow Chemical Co.). In some embodiments, a glycol ether is present in an amount of from about 1.0 wt.-% to about 20 wt.-%.

Methods of Cleaning

In some aspects, the present invention provides methods for removing soil from a surface. In some embodiments, the methods for removing soil from a surface include using a clean out of place (COP) or clean in place (CIP) cleaning process. The methods include applying to the surface a composition of the invention, preferably in form of foam, including at least one of an iron(III) activator complex, preferably an iron(III) gluconate, a source of alkalinity, preferably NaOH, and an active oxygen source, preferably H₂O₂. Additional ingredients may also be present in the compositions. The iron(III) activator complex, source of alkalinity, and active oxygen source may be applied to the surface in a variety of ways. For example, the activator complex, source of alkalinity, and active oxygen source may be applied to the surface as part of a single composition, preferably in form of foam (COP).

In other embodiments, combinations of each of the components may be applied to the surface. For example, in some embodiments, the activator complex and source of alkalinity are applied in a first step, preferably as foam, and the active oxygen source is applied in a second step, preferably as foam, without a rinse step between the first and the second steps. Additional ingredients including, but not limited to, builders, surfactants, and chelating agents may be added to the compositions used in the first step, the second step, or both the first and the second steps. The composition of the first step may be applied to the surface for an amount of time effective to penetrate the soil. For example, the first step may be applied to the surface to be cleaned for between about ≧5 minutes to about ≦30 minutes.

In other embodiments, an active oxygen source and a source of alkalinity are applied as stable foam to the surface in a first step, and an iron(III) activator complex is applied to the surface in second step, without a rinse step between the first and the second steps.

Surfaces

In some embodiments, the methods and compositions of the present invention are applied to surfaces which are normally cleaned using a clean out of place or in place cleaning technique. Examples of such surfaces include hard and soft surface, for example of upper outer and/or inner outer surfaces of materials such as ceramic, metal, plastic and/or glass, surface that came into contact with beverages and/or food, beverages such alcoholic or non-alcoholic beverages such as beer or milk, food such as meat, vegetables and/or grain-products. Other surfaces that can be cleaned are instruments and apparatus, for example used in sanitary or medical services, evaporators, heat exchangers, including tube-in-tube exchangers, direct steam injection, and plate-in-frame exchangers, heating coils including steam, flame or heat transfer fluid heated re-crystallizers, pan crystallizers, spray dryers, drum dryers, and tanks.

Additional surfaces capable of being cleaned using the methods and compositions of the present invention include, but are not limited to membranes, medical devices, laundry and/or textiles, and hard surfaces, e.g., walls, floors, dishes, flatware, pots and pans, heat exchange coils, ovens, fryers, smoke houses, sewer drain lines, and vehicles. In some embodiments, the surfaces may be cleaned using a clean in place method. The methods of the present invention may also be used to remove dust from air handling equipment, for example, from air conditioners and refrigeration heat exchangers. In other embodiments, the methods of the present invention may be used for drain line microbial control, e.g., to reduce or remove biofilm formation.

Exemplary industries in which the methods and compositions of the present invention may be used include, but are not limited to: the food and beverage industry, e.g., the dairy, cheese, sugar, and brewery industries; oil processing industry; industrial agriculture and ethanol processing; and the pharmaceutical manufacturing industry.

Temperature

The methods and compositions of the present invention provide for soil removal from surfaces at reduced temperatures, e.g., from about ≧5° C. to about ≦23° C., preferably at about ≧7° C. to about ≦18° C., preferably about ≧10° C. to about ≦15° C. compared to conventional cleaning techniques, e.g., clean out of place and/or clean in place techniques. Without wishing to be bound by any particular theory, it is thought that the use of an iron(III) activator complex in conjunction with an active oxygen source and a source of alkalinity and an excess of C₄ to C₁₈ hydroxymonocarboxylate allows for the generation of oxygen gas on and in a soil, without the use of heat activation.

The ability of stable foam formation and to clean at reduced temperatures, preferably at about 15° C. results in energy and cost savings compared to traditional cleaning techniques that require increased temperatures. Further, the present invention provides for effective soil removal on surfaces that cannot withstand high temperatures.

It has also been found that the methods of the present invention provide for soil removal at reduced temperatures, and using reduced amounts of chemistry, compared to conventional cleaning methods. In some embodiments, the methods of the present invention use about 25% to about 50% less chemistry, e.g., source of alkalinity and/or active oxygen source, than conventional cleaning methods. Thus, the methods of the present invention may effectively remove soil at both low temperatures, and using a low concentration of chemicals, providing both an energy savings and a reduction in the amount of chemistry consumed per cleaning.

Time

In some aspects of the invention, the compositions for use with the methods of the present invention are applied as stable foam to the surface for a sufficient amount of time such that the composition penetrates into the soil to be removed. This penetration into the soil allows for oxygen gas generation to occur in the soil. Although the methods of the present invention are carried out at lower temperatures than conventional cleaning methods, an increased cleaning time is not required to achieve equal or better cleaning results than conventional cleaning methods.

In some aspects, a composition including at least one of an iron(III) activator complex, an active oxygen source, and a source of alkalinity and an excess of C₄ to C₁₈ hydroxymonocarboxylate is applied as a stable foam to a surface for an amount of time sufficient to substantially remove a soil from the surface. In some embodiments, the composition is applied to the surface for about 1 minutes to about 60 minutes, preferably about 5 minutes to about 55 minutes, further preferred about 10 minutes to about 50 minutes.

In other embodiments, the composition is applied to the surface for about 20 to about 40 minutes. It is to be understood that all values and ranges between these values and ranges are encompassed by the methods of the present invention.

In some aspects, a pre-treatment foamed composition including at least one of an iron(III) activator complex, an active oxygen source, and a source of alkalinity, is applied to the surface for an amount of time sufficient to substantially penetrate a soil on the surface. In some embodiments, the pre-treatment foamed composition of the invention is applied to the surface to be cleaned for about 1 to about 30 minutes. In some embodiments, the pre-treatment foamed composition is applied to the surface to be cleaned for about 5 to about 15 minutes. In some embodiments, the pre-treatment foamed composition is applied to the surface for about 10 minutes. It is to be understood that any value between these ranges is to be encompassed by the methods of the present invention.

In some aspects of the present invention, an foamed composition including at least one of an iron(III) activator complex, an active oxygen source, and a source of alkalinity, is applied as a stable foam to a surface to be cleaned after a pre-treatment foamed composition has been applied to the surface, i.e., there is no rinse step between the application of the pre-treatment foamed composition and the foamed composition.

In some embodiments, the -foamed composition is applied to the surface for an amount of time sufficient to effectively clean the selected surface, and to activate the pre-treatment chemistry, e.g., generate oxygen gas. In some embodiments, the foamed composition is applied for about 1 to about 30 minutes. In some embodiments, the use foamed composition is applied for about 5, about 10, or about 15 minutes. It is to be understood that all values and ranges between these values and rages are encompassed by the methods of the present invention.

In some other embodiments, the source of peroxide source is added before, after and/or simultaneous with the application of the composition of component A to the surface to be cleaned, preferably the peroxide source is added simultaneous with the application of the composition of component A to the surface to be cleaned.

In some embodiments, the method of cleaning comprises the steps:
a) optional applying a pre-treatment solution to the surface to be cleaned for an amount of time sufficient to substantially penetrate a soil on the surface to be cleaned and/or pre-clean a soil on the surface to be cleaned;
b) applying a foamed composition of claims 1 to 11 to the surface to be cleaned for an amount of time for cleaning the surface to be cleaned;
c) optional a rinsing step before and/or after the application (a) and/or (b).

In a further embodiment, the pre-treatment foamed composition is applied to the surface to be cleaned at between about ≧1° C. to about ≦30° C., preferably at between about ≧5° C. to about ≦25° C., further preferred at between about ≧7° C. to about ≦20° C. and more preferred about ≧10° C. to about ≦15° C.

### Examples

The present invention is more particularly described in the following examples that are intended as illustrations only. Unless otherwise noted, all parts, percentages, and ratios reported in the following examples are on a weight basis, and all reagents used in the examples were obtained, or are available, from the chemical suppliers described below, or may be synthesized by conventional techniques.

The cleaning composition as shown in table is a mixture of component A) and component B), wherein the component A) comprises:
NaOH as source of alkalinity,
X as surfactant,
an iron(III) activator complex, see table II below; and

wherein the component B) comprises:

H₂O₂ as a source of peroxide.

Exemplary liquid cleaning compositions used for providing a foam by spray technique are shown in the table I below.

TABLE I

| Cleaning compositions + | | |
|---|---|---|
| activator complex | | Concentration (wt.-%) |
| Source of | Iron activator complex | see table II Examples 1 to 4 |
| alkalinity | NaOH | 15.0 wt.-% |
| | N,N-dimethyl dodecyl amine | 6.0 wt.-% (Surfactant) |
| | N-oxide | |
| | Water | Add. water to 100 wt. % |
| Source of | H₂O₂ | 30.0 wt.-% |
| peroxide | Water | Add. water to 100 wt. % |

The cleaning compositions of examples 1 to 4 of table I contain various activator complexes as outlined in table II of examples 1 to 4. Examples 1 and 2 are foamed cleaning compositions containing an Fe(II)SO₄/gluconic acid activator complex. Examples 3 and 4 are foamed cleaning compositions containing an Fe(III)₂(SO₄)3/gluconic acid activator complex.

The average cleaning efficiency for the cleaning compositions of examples 1 to 4 for removing tallow soil at a temperature of 15° C. for a period of 15 minutes are recorded in table II below.

Cleaning Efficiency Test Method

This test method provides a basis to assess the foam compositions according to the invention for cleaning efficiency of glass surfaces contaminated with tallow soils.

### Equipment

Transparent plastic sticks
500 ml beaker

### Acetone

Tallow (soil)

### Spattle

Stainless steel test plates of 10 cm×5 cm×0.5 cm (The stainless steel test plates are cleaned with acetone before use)
Clean paper toweling
Stop watch
Drying oven
Analytical balance capable of weighing to 0.0001 g.

The stainless steel test plates were cleaned before use with acetone, cleaned thereafter with a clean paper toweling and allowed to dry at room temperature for about 12 hours. The upper surface of said stainless steel test plates were homogenously coated with tallow (see table II) so that a boundary area of 10% remains not coated. Thereafter the coated stainless steel test plates were weighed and the weight was recorded respectively (see table II). Then, the plates were cooled at 2° C. for about 12 hours. The cooled tallow coated test plates were completely soaked and up right placed in the cleaning composition of examples 1 to 4 of table II at a temperature of 15° C. After 10 minutes the so treated stainless steel test plate were allowed to dry at ambient temperature at about 23° C. for 15 hours. After that, the stainless steel test plates were scaled again to determine tallow removal effectiveness as shown in table

TABLE II

| Cleaning composition | steel plate | steel plate + | Amount of | after | Amount of | Cleaning | |
|---|---|---|---|---|---|---|---|
| of examples 1 to 5 | weight | tallow | tallow added | cleaning | tallow removed | efficiency | Average |
| [wt.-%] | [g] | [g] | [g] | [g] | [g] | [%] | [%] |
| Example 1 | 38.2734 | 38.2945 | 0.0211 | 38.2908 | 0.0037 | 18 | |
| Fe(II)SO₄/gluconic | 38.8765 | 38.8982 | 0.0217 | 38.8916 | 0.0066 | 30 | |
| acid (1:3), | 38.7534 | 38.7706 | 0.0172 | 38.7698 | 0.0008 | 5 | |
| 0.015 wt.-% | 38.5025 | 38.5273 | 0.0248 | 38.5227 | 0.0046 | 19 | |
| | 39.4998 | 39.5087 | 0.0089 | 39.5072 | 0.0015 | 17 | 18 |
| Example 2 | 38.8416 | 38.8698 | 0.0282 | 38.8593 | 0.0105 | 37 | |
| Fe(II)SO₄ gluconic | 38.4698 | 38.4926 | 0.0228 | 38.4825 | 0.0101 | 44 | |
| acid (1:3), | 38.7517 | 38.7792 | 0.0275 | 38.7706 | 0.0086 | 31 | |
| 0.03 wt.-% | 38.1001 | 38.1207 | 0.0206 | 38.1133 | 0.0074 | 36 | |
| | 40.0634 | 40.0816 | 0.0182 | 40.0747 | 0.0069 | 38 | 37 |
| Example 3 | 38.7293 | 38.7576 | 0.0283 | 38.7432 | 0.0144 | 51 | |
| Fe₂(III)(SO₄)₃/gluconic | 38.8203 | 38.8698 | 0.0495 | 38.8400 | 0.0298 | 60 | |
| acid (1:3), | 37.4999 | 37.5377 | 0.0378 | 37.5097 | 0.0280 | 74 | |
| 0.015 wt.-% | 37.4925 | 37.5241 | 0.0316 | 37.5008 | 0.0233 | 74 | |
| | 38.9410 | 38.9730 | 0.0320 | 38.9540 | 0.0190 | 59 | 64 |
| Example 4 | 38.5052 | 38.5474 | 0.0422 | 38.5073 | 0.0401 | 95 | |
| Fe₂(III)(SO₄)₃/gluconic | 38.7708 | 38.7951 | 0.0243 | 38.7717 | 0.0234 | 96 | |
| acid (1:3), | 38.9710 | 38.9946 | 0.0236 | 38.9725 | 0.0221 | 94 | |
| 0.03 wt.-% | 37.7078 | 37.7294 | 0.0216 | 37.7087 | 0.0207 | 96 | |
| | 38.7008 | 38.7330 | 0.0322 | 38.7036 | 0.0294 | 91 | 94 |

As can be seen from these results of table I, examples 3 and 4 comprising an activator complex of Iron(III) gluconic acid show excellent cold cleaning activity compared to an Iron(II) activator complex. It can be further taken from table II that an excess of gluconic acid increase the soil removal activity of the activator complex of the present invention.

Foam Formation Test

This test method provides a basis to assess the foam formation properties of the foam cleaning composition of the invention.

### Foam Testing Equipment

250 ml long-necked glass cylinder
Rubber stopper to close the long-necked glass cylinder

### Test Method

50 ml of the cleaning compositions of examples 3 to 4 were filled each into a long-necked glass cylinder, respectively. The long-necked glass cylinder was then turned up and down 20 times in 20 seconds. Thereafter the glass cylinder was placed and the foam depth of each cylinder was scaled in ml to determine the foam formation. This test was carried out at a temperature of the cleaning foamed composition at ambient temperature, 15° C. and 23° C. The results are shown in table III below.

TABLE III

| | Foam height | Foam | Foam height | Foam |
|---|---|---|---|---|
| | at 15° C. | reduction [%] | at 23° C. | reduction [%] |
| Example 3 | | | | |
| Time | | | | |
| 0 | 216 ml | 0 | 220 ml | 0 |
| 1 | 174 ml | 19 | 188 ml | 15 |
| 2 | 164 ml | 24 | 170 ml | 23 |
| 5 | 138 ml | 36 | 140 ml | 36 |
| 10 | 40 ml | 81 | 50 ml | 77 |
| Example 4 | | | | |
| Time | | | | |
| 0 | 236 ml | 0 | 240 ml | 0 |
| 1 | 204 ml | 14 | 210 ml | 13 |
| 2 | 186 ml | 21 | 196 ml | 18 |
| 5 | 142 ml | 40 | 160 ml | 33 |
| 10 | 40 ml | 83 | 60 ml | 75 |

### Other Embodiments

It is to be understood that while the invention has been described in conjunction with the detailed description thereof, the foregoing description is intended to illustrate, and not limit the scope of the invention, which is defined by the scope of the appended claims. Other aspects, advantages, and modifications are within the scope of the following claims.

In addition, the contents of all patent publications discussed supra are incorporated in their entirety by this reference.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

1. An aqueous composition for removing soil at low temperatures from a surface to be cleaned, comprising a source of alkalinity, a surfactant, an iron(III) activator complex and a source of peroxide.

2. The composition of claim 1, wherein the composition is an aqueous two component composition for removing soil at low temperatures from a surface to be cleaned, comprising a component A) and a component B),
wherein the component A) comprises:
a source of alkalinity,
a surfactant,
an iron(III) activator complex, preferably an iron(III) C₄ to C₁₈ hydroxymonocarboxylate activator complex, comprising C₄ to C₁₈ hydroxymonocarboxylate in excess; and
wherein the component B) comprises:
a source of peroxide.

3. The composition of claim 1, wherein the mole ratio of iron(III) to C₄ to C₁₈ hydroxymonocarboxylate is in the range of about 1:1.1 to 1:10.

4. The composition of claim 1, wherein the C₄ to C₁₈ hydroxymonocarboxylate is selected from the group comprising citrate; propionate; gluconate; glycolate; glucoheptanoate; succinate; lactate; methyllactate; 2-hydroxybutanoate; mandelate; atrolactate; phenyllactate; glyerate; 2,3,4-trihydroxybutanoate; alpha hydroxylaurate; benzillate; isocitrate; citramalate; agaricate; quinate; uronates, including glucuronate, glucuronolactonate, galaturonate, galacturonolactonate; hydroxypyruvate; ascorbate; and/or tropate, most preferred is gluconate.

5. The composition of claim 2, wherein the source of alkalinity is selected from the group comprising basic salts, amines, alkanol amines, carbonates, silicates, and mixtures thereof, preferably the source of alkalinity is selected from the group comprising sodium hydroxide, potassium hydroxide or a mixture thereof, most preferred is sodium hydroxide.

6. The two component composition of claim 1, wherein the surfactant is selected from the group comprising of a anionic surfactant and/or a non-ionic surfactant, preferably the surfactant is selected from the group comprising of linear alkyl benzene sulfonates, alcohol sulfonates, amine oxides, alkyl glucosides, alcohol ethoxylates, alkyl phenol ethoxylates, polyethylene glycol esters, EO/PO block copolymers, and mixtures thereof, preferably the surfactant is selected from the group comprising of linear alkyl benzene sulfonates, amine oxides, alkyl glucosides and mixtures thereof and most preferred the surfactant is selected from the group comprising of amine oxides, alkyl glucosides and mixtures thereof.

7. The two component composition of claim 1, wherein the source of peroxide is selected from the group comprising hydrogen peroxide, peracetic acid, peroctanoic acid, a persulphate, a perborate, a percarbonate and mixtures and derivatives thereof, preferably hydrogen peroxide, peracetic acid, peroctanoic acid and mixtures and derivatives thereof, and most preferred hydrogen peroxide.

8. The two component composition of claim 1, wherein the composition comprises:
≧5 wt.-% to about ≦70 wt. %, of the source of alkalinity comprised of sodium hydroxide;
≧0.01 wt.-% to about ≦30 wt. % of a surfactant;
≧0.001 wt.-% to about ≦10 wt. % of an iron(III) C₄ to C₁₈ hydroxymonocarboxylate activator complex comprised of an iron(III) gluconate activator complex;
≧10 wt.-% to about ≦80 wt.-%, preferably ≧20 wt.-% to about ≦70 wt.-%, and more preferred ≧30 wt.-% to about ≦50 wt.-%, of a solvent, preferably water;
≧5 wt.-% to about ≦70 wt. % of a source of peroxide comprised of hydrogen peroxide;
≧10 wt.-% to about ≦80 wt. % of a solvent comprised of water; wherein the weight % of the components are based on the total weight of the composition and the total wt.-% of all components of the composition does not exceed 100 wt.-%.

9. A foam composition comprising the mixed components of claim 1.

10. The foam composition of claim 9 having a foam stability, wherein the reduction of foam volume after 1 minute is about 10 vol.-% to 20 vol.-%, after 2 minute is about 15 vol.-% to 25 vol.-%, after 5 minute is about 30 vol.-% to 40 vol.-% and after 10 minute is about 75 vol.-% to 85 vol.-%, based on the initial foam volume.

11. The foam composition of claim 9 having a mean foam pore size D₅₀ in the range of ≧100 μm to about ≦500 μm.

12. A method for removing soil from a surface to be cleaned comprising applying to the surface a composition of claim 1.

13. The method of claim 12, wherein the source of peroxide source is added simultaneous with the application of the composition of component A to the surface to be cleaned.

14. The method of claim 12 comprising:
a) applying a pre-treatment solution to the surface to be cleaned for an amount of time sufficient to substantially penetrate a soil on the surface to be cleaned or pre-clean a soil on the surface to be cleaned;
b) applying a foamed composition of claim 1 to the surface to be cleaned for an amount of time for cleaning the surface to be cleaned;
c) a rinsing step before and/or after the application (a) and/or (b).

15. The method of claim 14, wherein the pre-treatment foamed composition is applied to the surface to be cleaned at between about ≧10° C. to about ≦15° C.

16. Use of the composition of claim 1 for removing soil from a surface to be cleaned, preferably in a clean-out-of-place systems (COP) or in a clean-in-place system (CIP).
